(19) United States
(12) Patent Application Publication
(10) Pub. No.: US 2015/0078369 A1
(43) Pub. Date: Mar. 19, 2015

(54) METHOD AND APPARATUS FOR DISSEMINATION OF TIMING INFORMATION IN DISTRIBUTED SYNCHRONIZATION DEVICE TO DEVICE NETWORKS

(71) Applicant: QUALCOMM Incorporated, San Diego, CA (US)

(72) Inventors: Nilesh N. KHUDE, Bridgewater, NJ (US); Saurabha R. TAVILDAR, Jersey City, NJ (US); Sebastien HENRI, Paris (FR); Navid ABEDINI, Raritan, NJ (US); Junyi LI, Chester, NJ (US); Vincent D. PARK, Budd Lake, NJ (US)

(73) Assignee: QUALCOMM Incorporated, San Diego, CA (US)

(21) Appl. No.: 14/029,752

(22) Filed: Sep. 17, 2013

(51) Int. Cl. H04W 56/00

(52) U.S. Cl. CPC H04W 56/002
USPC 370/350

(57) ABSTRACT

A method, an apparatus, and a computer program product for wireless communication are provided in connection with improving convergence to a common timing structure for devices in a distributed synchronization D2D network. In an example, a communications device is equipped to detect, by a UE, a synchronization signal during a listening slot duration scan of a communication channel. In an aspect, the listening slot duration may be defined based on a first timing structure, and the synchronization signal may be defined based on a second timing structure. The communications device may further be equipped to obtain timing information associated with the second timing structure from the synchronization signal, and determine whether the first timing structure or the second timing structure is a preferred timing structure.

### BACKGROUND

1. Field

The present disclosure relates generally to communication systems, and more particularly, to dissemination of timing information in distributed synchronization device to device (D2D) communications systems.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. LTE may support direct device-to-device (peer-to-peer) communication.

In a distributed synchronization D2D communication system (e.g., where the UEs may not have access to any common source of synchronization (e.g., wireless access network (WAN) based, global positing system (GPS) receiver based, etc.)), the UEs may synchronize through use of distributed protocols. These protocols may use resource for synchronization (e.g., synchronization channel resources) which may be allocated on a slow time scale (e.g. once every second) to reduce battery expenditure as well as the amount of resources used for the synchronization. Multiple user equipment (UEs) may transmit in multiple broadcast resources available in the synchronization channel, and may receive the transmissions on these resources to obtain timing structure information, frame structure information, time and frequency corrections, other channels' allocations, etc. Further, multiple timing structures may exist in a connected network. Existence of these multiple timing structures can result from changes in network topology over time caused by addition/deletion/mobility of the devices. As a common timing structure facilitates efficient device discovery, better scheduling of transmissions and interference management, it may be desired that the devices in a connected network follow a common timing structure.

As such, a system and method to improve convergence to a common timing structure for devices in a distributed synchronization D2D network may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with improving convergence to a common timing structure for devices in a distributed synchronization D2D network. In an example, a communications device is equipped to detect, by a UE, a synchronization signal during a listening slot duration scan of a communication channel. In an aspect, the listening slot duration may be defined based on a first timing structure, and the synchronization signal may be defined based on a second timing structure. The communications device may further be equipped to obtain timing information associated with the second timing structure from the synchronization signal, and determine whether the first timing structure or the second timing structure is a preferred timing structure.

According to related aspects, a method for improving convergence to a common timing structure for devices in a distributed synchronization D2D network is provided. The method can include detecting, by a UE, a synchronization signal during a listening slot duration scan of a communication channel. In an aspect, the listening slot duration may be defined based on a first timing structure, and the synchronization signal may be defined based on a second timing structure. Further, the method can include obtaining timing information associated with the second timing structure from the synchronization signal. Moreover, the method may include determining whether the first timing structure or the second timing structure is a preferred timing structure.

Another aspect relates to a communications apparatus enabled to improve convergence to a common timing structure for devices in a distributed synchronization D2D network. The communications apparatus can include means for detecting, by a UE, a synchronization signal during a listening slot duration scan of a communication channel. In an aspect, the listening slot duration may be defined based on a first timing structure, and the synchronization signal may be defined based on a second timing structure. Further, the communications apparatus can include means for obtaining timing information associated with the second timing structure from the synchronization signal. Moreover, the communications apparatus can include means for determining whether the first timing structure or the second timing structure is a preferred timing structure.

Another aspect relates to a communications apparatus. The apparatus can include a processing system configured to detect a synchronization signal during a listening slot duration scan of a communication channel. In an aspect, the listening slot duration may be defined based on a first timing structure, and the synchronization signal may be defined based on a second timing structure. Further, the processing system may be configured to obtain timing information associated with the second timing structure from the synchronization signal. Moreover, the processing system may further be configured to determine whether the first timing structure or the second timing structure is a preferred timing structure.

Still another aspect relates to a computer program product, which can have a computer-readable medium including code for detecting, by a UE, a synchronization signal during a listening slot duration scan of a communication channel. In an aspect, the listening slot duration may be defined based on a first timing structure, and the synchronization signal may be defined based on a second timing structure. Further, the computer-readable medium may include code for obtaining timing information associated with the second timing structure from the synchronization signal. Moreover, the computer-readable medium can include code for determining whether the first timing structure or the second timing structure is a preferred timing structure.

According to related aspects, a method for improving convergence to a common timing structure for devices in a distributed synchronization D2D network is provided. The method can include detecting, by a UE, timing information received during a synchronization channel duration associated with a first timing structure. In an aspect, the timing information includes timing information for a synchronization channel associated with a preferred timing structure which is different than the first timing structure. Moreover, the method may include aligning UE communications timing with the preferred timing structure.

Another aspect relates to a communications apparatus enabled to improve convergence to a common timing structure for devices in a distributed synchronization D2D network. The communications apparatus can include means for detecting, by a UE, timing information received during a synchronization channel duration associated with a first timing structure. In an aspect, the timing information includes timing information for a synchronization channel associated with a preferred timing structure which is different than the first timing structure. Moreover, the communications apparatus can include means for aligning UE communications timing with the preferred timing structure.

Another aspect relates to a communications apparatus. The apparatus can include a processing system configured to detect timing information received during a synchronization channel duration associated with a first timing structure. In an aspect, the timing information includes timing information for a synchronization channel associated with a preferred timing structure which is different than the first timing structure. Moreover, the processing system may further be configured to align UE communications timing with the preferred timing structure.

Still another aspect relates to a computer program product, which can have a computer-readable medium including code for detecting, by a UE, timing information received during a synchronization channel duration associated with a first timing structure. In an aspect, the timing information includes timing information for a synchronization channel associated with a preferred timing structure which is different than the first timing structure. Moreover, the computer-readable medium can include code for aligning UE communications timing with the preferred timing structure.

According to related aspects, a method for improving convergence to a common timing structure for devices in a distributed synchronization D2D network is provided. The method can include determining, by a UE, a presence of a preferred timing structure. In an aspect, the UE is currently using a first timing structure for communications, and the preferred timing structure is different than the first timing structure. Moreover, the method may include transmitting timing information associated with the preferred timing structure during a synchronization channel duration associated with the first timing structure.

Another aspect relates to a communications apparatus enabled to improve convergence to a common timing structure for devices in a distributed synchronization D2D network. The communications apparatus can include means for determining, by a UE, a presence of a preferred timing structure. In an aspect, the UE is currently using a first timing structure for communications, and the preferred timing structure is different than the first timing structure. Moreover, the communications apparatus can include means for transmitting timing information associated with the preferred timing structure during a synchronization channel duration associated with the first timing structure.

Another aspect relates to a communications apparatus. The apparatus can include a processing system configured to determine a presence of a preferred timing structure. In an aspect, the UE is currently using a first timing structure for communications, and the preferred timing structure is different than the first timing structure. Moreover, the processing system may further be configured to transmit timing information associated with the preferred timing structure during a synchronization channel duration associated with the first timing structure.

Still another aspect relates to a computer program product, which can have a computer-readable medium including code for determining, by a UE, a presence of a preferred timing structure. In an aspect, the UE is currently using a first timing structure for communications, and the preferred timing structure is different than the first timing structure. Moreover, the computer-readable medium can include code for transmitting timing information associated with the preferred timing structure during a synchronization channel duration associated with the first timing structure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of an evolved Node B and user equipment in an access network.

FIG. 6 is a diagram illustrating a device-to-device communications network.

FIG. 7 is a diagram illustrating a device-to-device communications network that is configured to improve convergence to a common timing structure for devices in a distributed synchronization D2D network, according to an aspect.

FIG. 8 is block diagram illustrating device-to-device communications network timing structures as time progresses, according to an aspect.

FIG. 9 is a flow chart of a first method of wireless communication.

FIG. 10 is a flow chart of a second method of wireless communication.

FIG. 11 is a flow chart of a third method of wireless communication.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

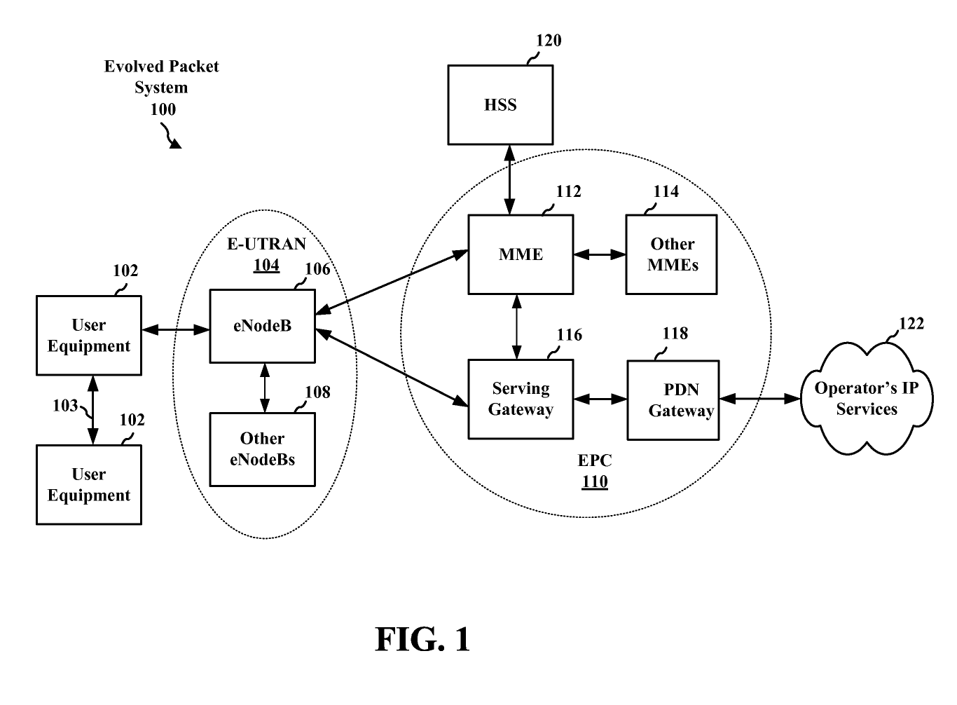

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The UEs 102 may form a D2D connection 103. In an aspect, the D2D connection 103 may be configured to allow the UEs 102 to communicate with each other. In another aspect, a UE 102 may act as a leader of a group of UEs that are able to communicate with each other using the D2D connection 103. Examples of D2D connection 103 are provided with reference to IEEE 802.11p based communications. IEEE 802.11p based dedicated short range communications (DSRC) wave systems provide a basic safety message format where devices (e.g., vehicles) periodically may announce their position, velocity and other attributes to other devices (e.g., other vehicles) allowing the neighboring traffic to track their positions and avoid collisions, improve traffic flow, etc. Further, the communication protocols in these systems do not preclude pedestrians (with their user equipment (UEs)) from utilizing this spectrum and periodically transmitting the basic safety messages which can indicate information such as their presence to vehicles around them.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

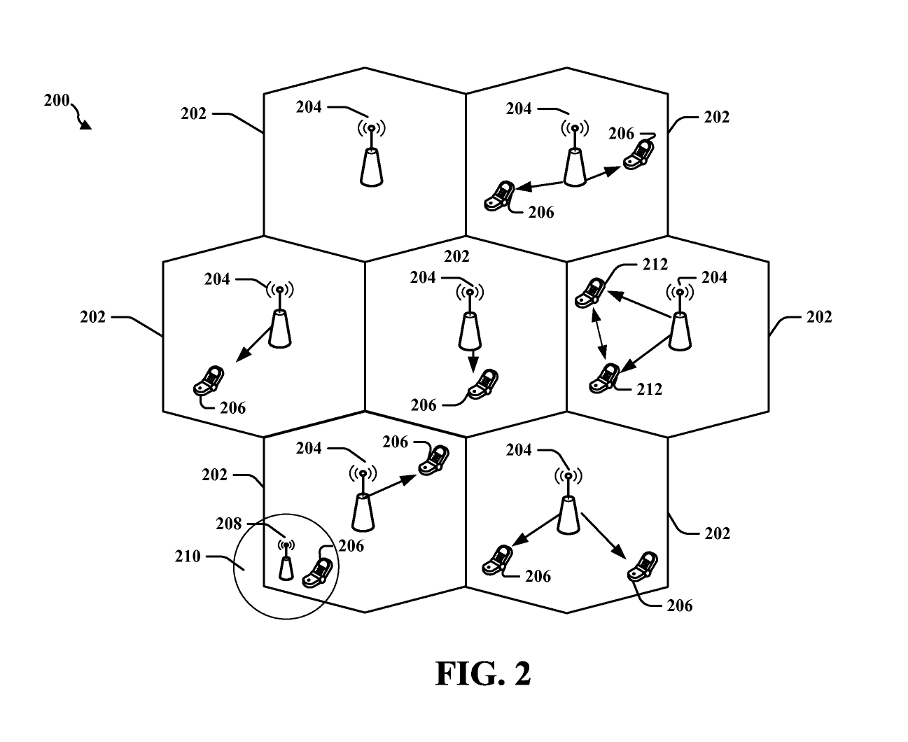

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206, 212 in the cells 202. Some of the UEs 212 may be in device-to-device communication. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

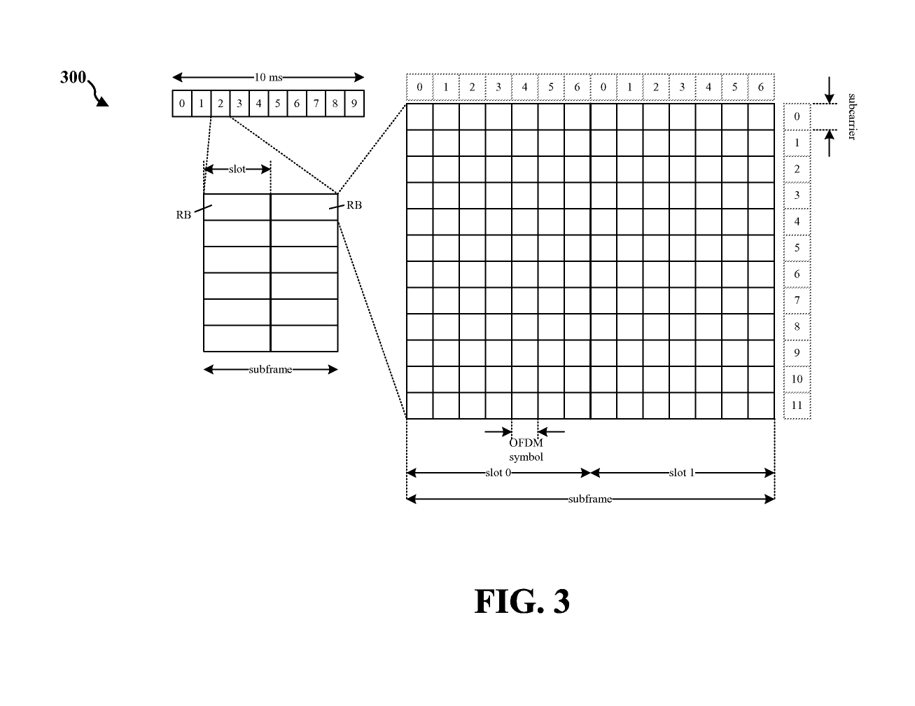

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. A physical DL control channel (PDCCH), a physical DL shared channel (PDSCH), and other channels may be mapped to the resource elements.

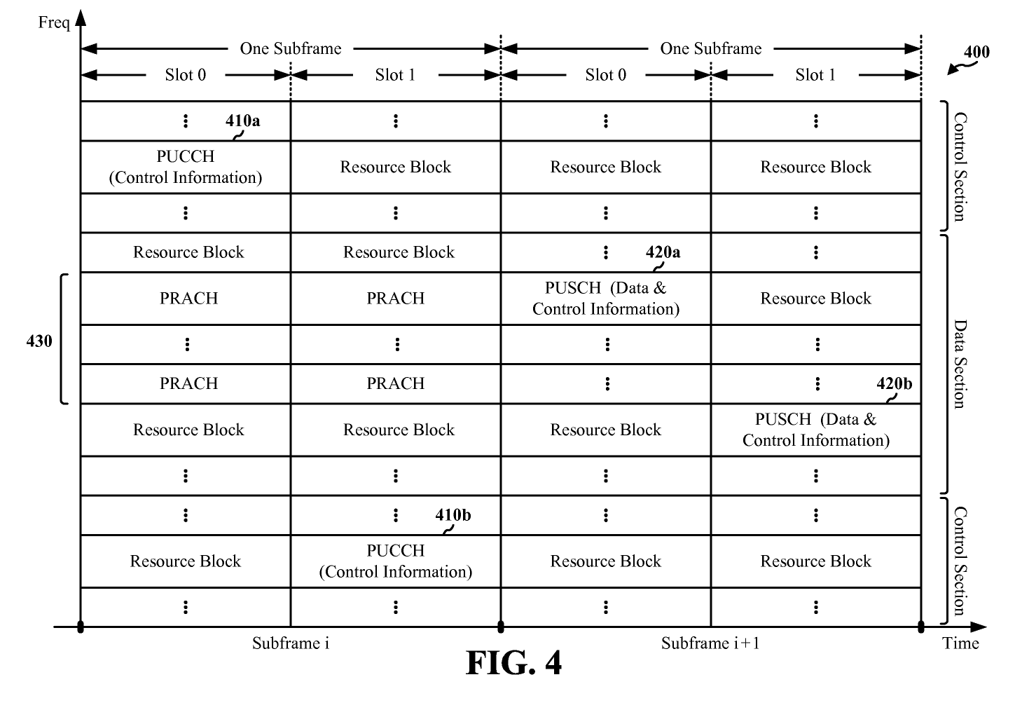

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

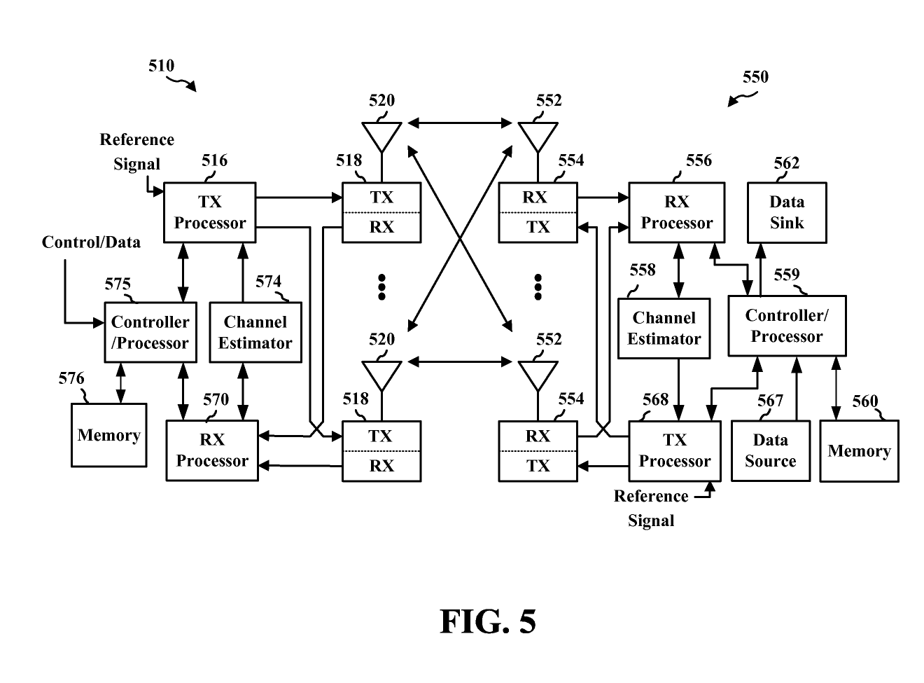

FIG. 5 is a block diagram of an eNB 510 in communication with a UE 550 in an access network. In the DL, upper layer packets from the core network are provided to a controller/processor 575. The controller/processor 575 implements the functionality of the L2 layer. In the DL, the controller/processor 575 provides header compression, ciphering, packet segmentation and reordering, multiplexing between logical and transport channels, and radio resource allocations to the UE 550 based on various priority metrics. The controller/processor 575 is also responsible for HARQ operations, retransmission of lost packets, and signaling to the UE 550.

The transmit (TX) processor 516 implements various signal processing functions for the L1 layer (i.e., physical layer). The signal processing functions includes coding and interleaving to facilitate forward error correction (FEC) at the UE 550 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 574 may be used to determine the coding and modulation scheme, as well as for spatial processing. The channel estimate may be derived from a reference signal and/or channel condition feedback transmitted by the UE 550. Each spatial stream is then provided to a different antenna 520 via a separate transmitter 518TX. Each transmitter 518TX modulates an RF carrier with a respective spatial stream for transmission.

At the UE 550, each receiver 554RX receives a signal through its respective antenna 552. In another aspect, UE 550 may communicate with other UEs similarly to how UE 550 communicates with eNB 510. Each receiver 554RX recovers information modulated onto an RF carrier and provides the information to the receive (RX) processor 556. The RX processor 556 implements various signal processing functions of the L1 layer. The RX processor 556 performs spatial processing on the information to recover any spatial streams destined for the UE 550. If multiple spatial streams are destined for the UE 550, they may be combined by the RX processor 556 into a single OFDM symbol stream. The RX processor 556 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 510. These soft decisions may be based on channel estimates computed by the channel estimator 558. The soft decisions are then decoded and deinterleaved to recover the data and control signals that were originally transmitted by the eNB 510 on the physical channel. The data and control signals are then provided to the controller/processor 559.

The controller/processor 559 implements the L2 layer. The controller/processor can be associated with a memory 560 that stores program codes and data. The memory 560 may be referred to as a computer-readable medium. In the UL, the controller/processor 559 provides demultiplexing between transport and logical channels, packet reassembly, deciphering, header decompression, control signal processing to recover upper layer packets from the core network. The upper layer packets are then provided to a data sink 562, which represents all the protocol layers above the L2 layer. Various control signals may also be provided to the data sink 562 for L3 processing. The controller/processor 559 is also responsible for error detection using an acknowledgement (ACK) and/or negative acknowledgement (NACK) protocol to support HARQ operations.

In the UL, a data source 567 is used to provide upper layer packets to the controller/processor 559. The data source 567 represents all protocol layers above the L2 layer. Similar to the functionality described in connection with the DL transmission by the eNB 510, the controller/processor 559 implements the L2 layer for the user plane and the control plane by providing header compression, ciphering, packet segmentation and reordering, and multiplexing between logical and transport channels based on radio resource allocations by the eNB 510. The controller/processor 559 is also responsible for HARQ operations, retransmission of lost packets, and signaling to the eNB 510.

Channel estimates derived by a channel estimator 558 from a reference signal or feedback transmitted by the eNB 510 may be used by the TX processor 568 to select the appropriate coding and modulation schemes, and to facilitate spatial processing. The spatial streams generated by the TX processor 568 are provided to different antenna 552 via separate transmitters 554TX. Each transmitter 554TX modulates an RF carrier with a respective spatial stream for transmission.

The UL transmission is processed at the eNB 510 in a manner similar to that described in connection with the receiver function at the UE 550. Each receiver 518RX receives a signal through its respective antenna 520. Each receiver 518RX recovers information modulated onto an RF carrier and provides the information to a RX processor 570. The RX processor 570 may implement the L1 layer.

The controller/processor 575 implements the L2 layer. The controller/processor 575 can be associated with a memory 576 that stores program codes and data. The memory 576 may be referred to as a computer-readable medium. In the UL, the controller/processor 575 provides demultiplexing between transport and logical channels, packet reassembly, deciphering, header decompression, control signal processing to recover upper layer packets from the UE 550. Upper layer packets from the controller/processor 575 may be provided to the core network. The controller/processor 575 is also responsible for error detection using an ACK and/or NACK protocol to support HARQ operations.

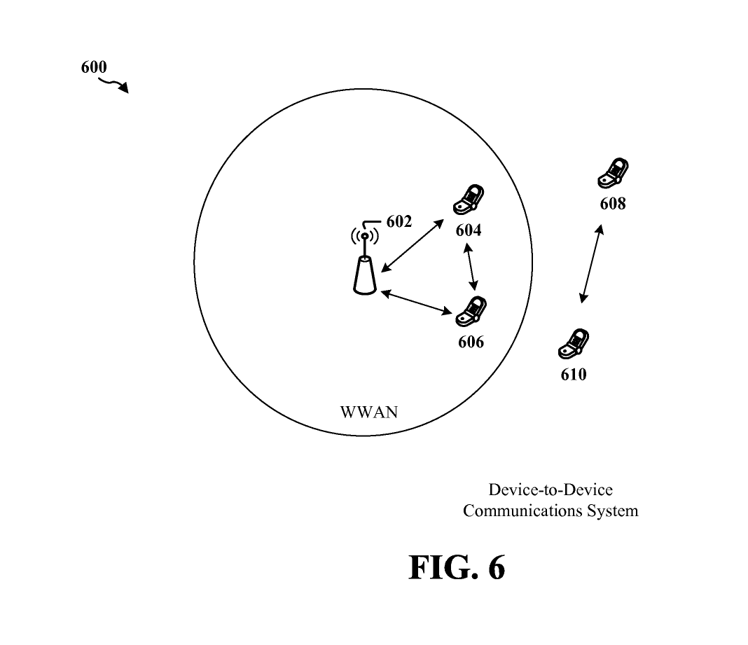

FIG. 6 is a diagram of a device-to-device communications system 600. The device-to-device communications system 600 includes a plurality of wireless devices 604, 606, 608, 610. The device-to-device communications system 600 may overlap with a cellular communications system, such as for example, a wireless wide area network (WWAN). Some of the wireless devices 604, 606, 608, 610 may communicate together in device-to-device communication using the DL/UL WWAN spectrum, some may communicate with the base station 602, and some may do both. For example, as shown in FIG. 6, the wireless devices 608, 610 are in device-to-device communication and the wireless devices 604, 606 are in device-to-device communication. The wireless devices 604, 606 are also communicating with the base station 602.

The wireless device may alternatively be referred to by those skilled in the art as user equipment (UE), a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless device-to-device communications systems, such as for example, a wireless device-to-device communication system based on FlashLinQ, WiMedia, Bluetooth, ZigBee, or Wi-Fi based on the IEEE 802.11 standard. To simplify the discussion, the exemplary methods and apparatus are discussed within the context of LTE. However, one of ordinary skill in the art would understand that the exemplary methods and apparatuses are applicable more generally to a variety of other wireless device-to-device communication systems.

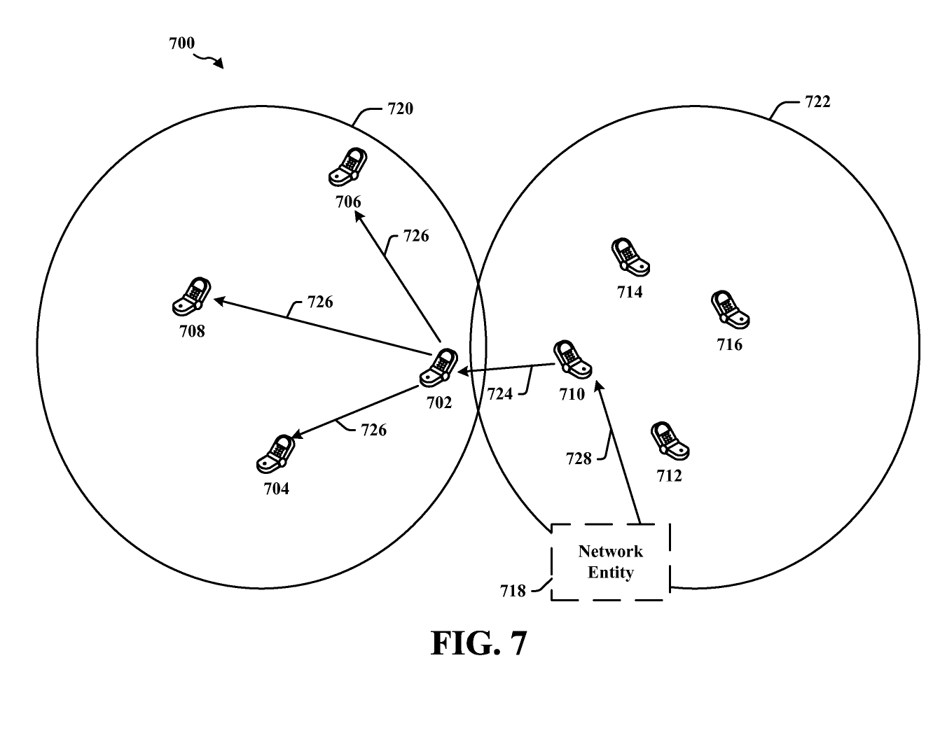

FIG. 7 is a diagram of a communications system 700 that is configured to support D2D communications.

In an aspect, multiple UEs (e.g., 702-708) may be synchronized through a first timing structure 720, while other UEs (e.g., 710-716) may be synchronized through a second timing structure 722. In such an aspect, one or more UEs (e.g., UE 702) may listen for the presence of another timing structure 722. The presence of another timing structure may be indicated through reception of a synchronization signal 724 associated with the other timing structure 722. Where such a timing structure 722 is detected and where the detected timing structure is determined to be preferred to the current timing structure 720, the UE (e.g., UE 702) may inform the others UEs (e.g., 704-708) using the first timing structure of the preferred timing structure 722. In such an aspect, the UE 702 may inform the other UEs (704-708) by including the synchronization information 724 for the preferred timing structure 722 in a synchronization message 726 associated with the first timing structure 720.

As such, all the UEs may align to the preferred timing structure 722. In an aspect, the determination as to which timing structure (720, 722) is preferred may be based on a largest age value, a largest MAC ID, access to a comparatively better timing source, a utility class ranking of the UE, etc. For example, UE 710 may have access to timing information 728 from a network entity 718. Network entity 718 may be a GPS entity, a WAN entity, etc.

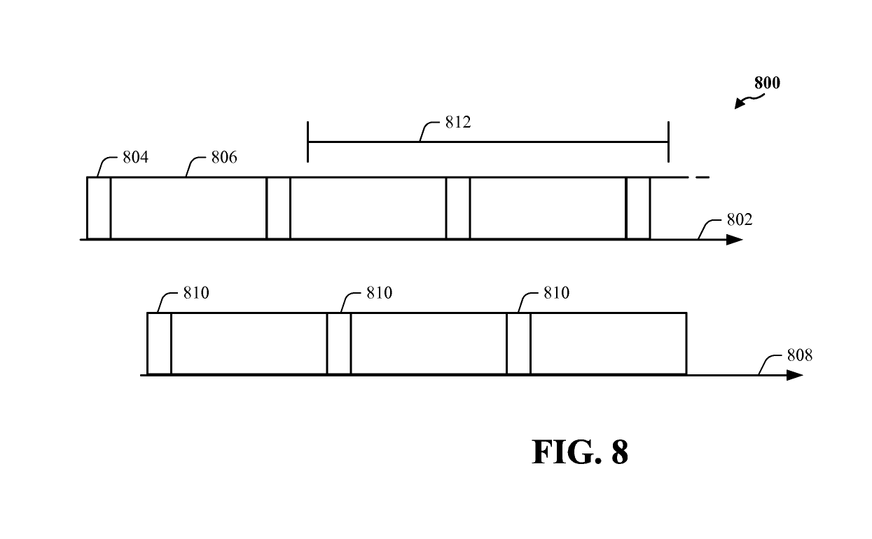

FIG. 8 is block diagram representing a connected network 800 associated with a D2D communication system as time progresses. Connected network 800 includes a first timing structure 802 and a second timing structure 808. The timing structures (802, 808) may be used by any UEs in the D2D communication system.

As depicted FIG. 8, the first timing structure 802 may include a synchronization period 804 and a communication period 806. Further, the second timing structure may also include a synchronization period 810 and a communication period. As described herein, the synchronization periods 804, 810 may also be referred to as synchronization channels.

In an aspect, devices associated with a timing structure (e.g., 802) may listen for a listening slot 812 to detect the potential presence of any other timing structures (e.g., 808). In an aspect, the listening slot 812 may cover a duration greater than or equal to the duration between two consecutive synchronization channels (e.g., 804) in a timing structure (e.g., 802). In an aspect, the listening slot 812 may be non-contiguous. That is, the listening slot 812 may cover multiple subslots which may be spread over multiple seconds. In such an aspect, these subslots may be chosen such that they span entire period between two consecutive synchronization channels (e.g., 804) in a timing structure (e.g., 802). For example, a listening slot 812 covering a duration 1 second may be split into 10 subslots of 100 ms that may be staggered over 10 seconds such that they cover one 1 second period. In another aspect, the listening slot 812 may be chosen pseudo-randomly during each slow time scale period (e.g., 100 seconds). The choice of listening slot 812 may depend on device specific information such as but not limited to, a Media Access Control identifier (MAC ID). As such, devices that follow the same timing structure may not all choose the same slot as a listening slot 812.

Subset of the devices that follow each timing structure (802, 808) may broadcast synchronization signals. Such synchronization signals may include information related to their respective timing structures (802, 808) and may be communicated in their respective synchronization channels (804, 810). In an aspect, the timing information may include system information, such as but not limited to, a frame structure and frame number, an identity associated with the timing structure, etc. For example, the identity of the timing structure may be a fixed ID, such as but not limited to, a pseudo-random number, a Service Set Identifier (SSID), a MAC ID of the device that initiated the timing structure, etc. In other examples, the identity of the timing structure may be a time varying ID such as the age of the network. In an aspect, the determination as to which timing structure is preferred may be based on a largest age value, a largest MAC ID, etc.

In another aspect, information in addition to the ID may be used to determine the preferred timing. For example, a device may not detect the presence of another timing structure that is a preferred timing structure, and/or may determine the presence of a comparatively better timing source (e.g., a device may have access to a GPS base timing value, a better clock value, a WAN provided timing value, a time value derived from being plugged in, etc.). In an aspect, such a device may be given preference to transmit in the resources in the synchronization channel reserved for periodic transmissions. Further, the devices in the network may be classified in multiple classes based on their utility in synchronization where devices with access to comparatively better timing sources may be given a high class value.

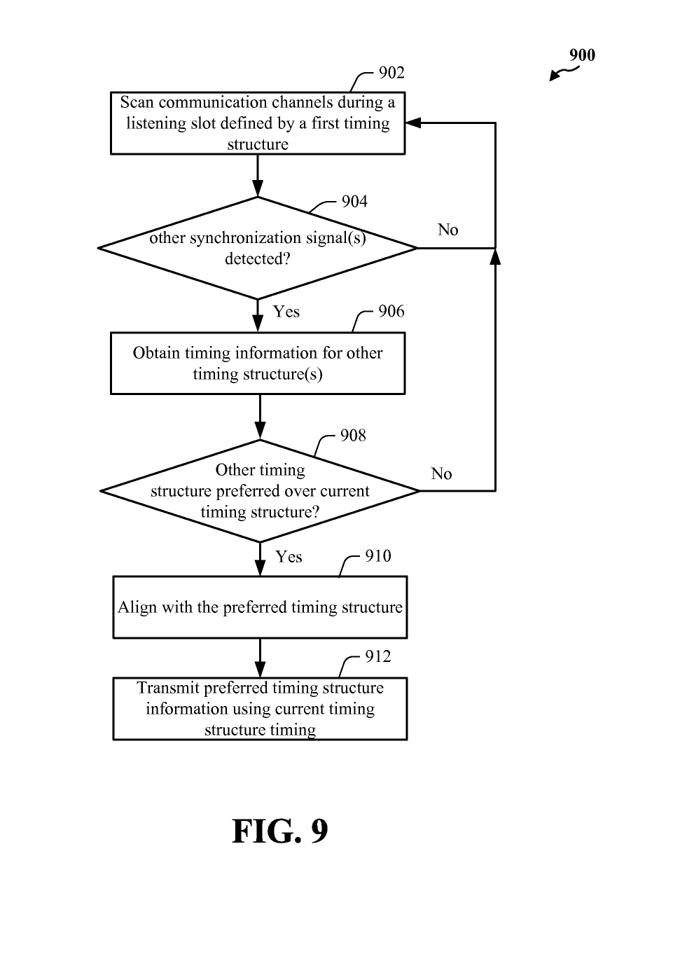

FIGS. 9, 10, and 11 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could be performed as a series of interrelated states or events, and/or substantially in parallel. Further, the various methodologies described in the blocks below may be performed individually or in any combination.

FIG. 9 is a flowchart of a first method 900 of wireless communication. The method may be performed by a UE in a D2D communication system.

At block 902, the UE may scan the environment (e.g., the surrounding D2D network) for a listening slot duration as defined by a first (e.g., current) timing structure. For example, apparatus 1202 reception module 1204 may be used to listen for one or more synchronization signals 1220 from devices (e.g., UE 710) that are using a different timing structure. In an aspect, the listening slot may cover a duration greater than or equal to the duration between two consecutive synchronization channels in a timing structure. In an aspect, the listening slot may be non-contiguous. That is, the listening slot may cover multiple subslots which may be spread over multiple seconds. In such an aspect, these subslots may be chosen such that they span entire period between two consecutive synchronization channels in a timing structure. For example, a listening slot covering a duration 1 second may be split into 10 subslots of 100 ms that may be staggered over 10 seconds such that they cover one 1 second period. In another aspect, the listening slot may be chosen pseudo-randomly during each slow time scale period (e.g., 100 seconds). In another aspect, the choice of listening slot may depend on device specific information such as but not limited to, a MAC ID. As such, devices that follow the same timing structure may not all choose the same slot as a listening slot.

At block 904, the UE determines whether one or more other synchronization signals have been detected. For example, the reception module 1204 may provide any received synchronization signals 1220 to timing structure detection module 1206 to detect synchronization information 1222 associated with the detected one or more other timing structures. If at block 904, the UE determines that no other timing structures are present, then the UE may return to scanning the network during the listening slot at block 902.

If at block 904, the UE determines that there are one or more other timing structures present within the vicinity of the UE, then at block 906, the UE obtains timing information associated with the one or more other timing structures. As noted above, for example, the reception module 1204 may provide any received synchronization signals 1220 to timing structure detection module 1206 to detect synchronization information 1222 associated with the detected one or more other timing structures.

At block 908, the UE may determine whether any of the obtained timing information is associated with a timing structure that is preferred over the currently used timing structure. For example, timing structure detection module 1206 may provide the detected synchronization information 1222 to preferred timing structure determination module 1210. Further, preferred timing structure determination module 1210 may have access to the currently used timing structure information 1224 from internal timing structure module 1208. As such, preferred timing structure determination module 1210 may determine which timing structure among the one or more detected timing structures (from the synchronization information 1222) and the currently used timing structure 1224 is the preferred timing structure 1226. In an aspect, the D2D network may bias timing structure preference to more accurate, more established, etc., timing values. If at block 908, the UE determines that no preferred timing structures are present, then the process may return to scanning the D2D network during a listening slot at block 902.

If at block 908, the UE determines that there is a preferred timing structure within the vicinity of the UE, then at block 910 the UE may align with the preferred timing structure. For example, preferred timing structure determination module 1210 may provide synchronization information associated with the preferred timing structure 1226 for transmission by transmission module 1210. In an aspect, the preferring timing structure information 1226 may be communicated to UE(s) (e.g., UEs 704-708) that are currently not using the preferred timing structure, and the transmission may be timed based on the currently used timing structure for the UE(s). In an operational aspect, the UE may obtain information of the timing structures (e.g., A, C, D, etc.) corresponding to the synchronization signals detected during the listening slot and determine a preferred timing structure (e.g., A). Where the preferred timing structure is not the timing structure that device is currently following (e.g., B), then the UE may adapt to the new timing structure (e.g., UE following timing structure B adapts to timing structure A).

At block 912, the UE may transmit timing information associated with the preferred timing structure. For example, transmission module 1210 may transmit the preferred timing structure information 1226. In an aspect, the UE may transmit the timing information during the synchronization period associated with the previously used timing structure. In another aspect, the UE may transmit the timing information associated with the preferred timing structure during synchronization periods associated with any non-preferred timing structure. In an aspect, the timing information may include an indication of a presence of the preferred timing structure, an identifier associated with the preferred timing structure, an offset between a synchronization channel associated with the first timing structure and the synchronization channel associated with the preferred timing structure, etc. In an aspect, a synchronization channel in a timing structure may have multiple resources for transmission of synchronization related information. Further, a subset of the devices may periodically transmit synchronization related information on these resources. The synchronization channel may also have resources assigned for random access and a UE may not transmit on these resources periodically, rather transmissions on these resources may be event driven. In an aspect, the UE may use resources reserved for periodic transmissions and/or random access resources to transmit information about the preferred timing structure. For example, where the resources for periodic transmissions are not available, the UE may decide to transmit in one of the random access resources. Such a transmission may indicate congestion in the periodic transmission resources, class of the transmitting UE indication its utility, etc. In such an aspect, a UE that transmits periodically on the resources in the synchronization channel may also be monitoring the random access resources. When another UE that was transmitting periodically detects the transmission indicating resource congestion transmitted by a device of higher class, the other UE may stop transmitting on the synchronization channel resource.

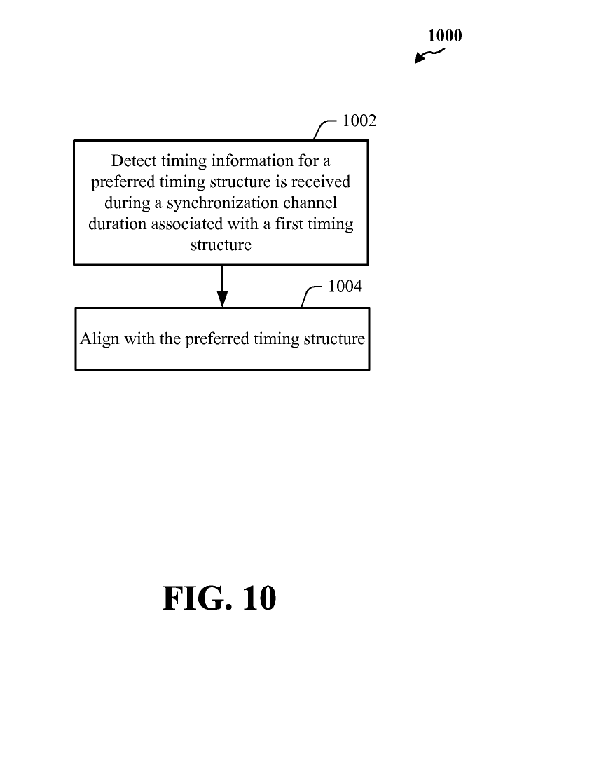

FIG. 10 is a flowchart of a second method 1000 of wireless communication. The method may be performed by a UE in a D2D communication system.

At block 1002, the UE may detect timing information associated with a preferred timing structure received during a synchronization channel duration associated with a first timing structure. In an aspect, the timing information is information for a synchronization channel associated with the preferred timing structure. For example, apparatus 1202 (e.g., UE 704) may receive the preferred timing structure information using reception module 1204 and may use preferred timing determination module 1208 to determine that the received signal includes the preferred timing structure information 1226. In an aspect, the timing information may include an offset between a synchronization channel associated with the preferred timing structure and the synchronization channel associated with the first timing structure.

At block 1004, the UE may align with the preferred timing structure. For example, the apparatus 1202 may update internal timing structure module 1208 to the preferred timing structure information and may transmit synchronization information using transmission module 1210 based on the preferred timing structure. In an aspect, the UE may scan for a listening slot duration to detect a synchronization channel associated with the preferred timing structure and align accordingly.

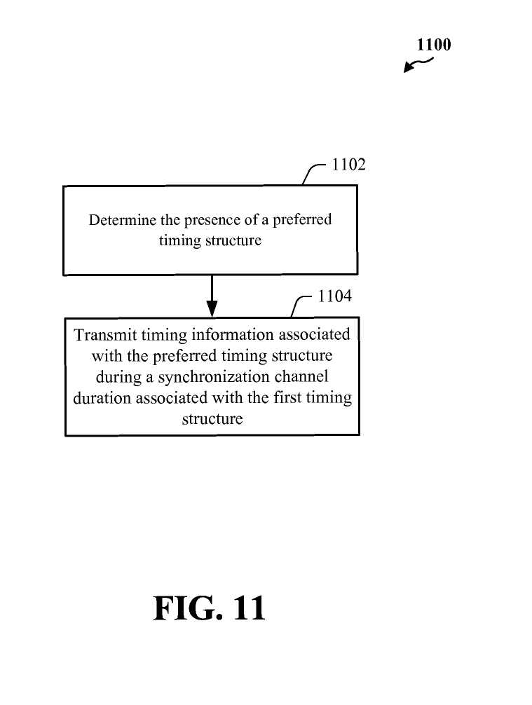

FIG. 11 is a flowchart of a third method 1100 of wireless communication. The method may be performed by a UE in a D2D communication system.

At block 1102, the UE may determine the presence of a preferred timing structure. For example, apparatus 1202 reception module 1204 may receive the timing information 1228 from a network entity (e.g., 718) that provides a preferred timing structure. In an aspect, the presence of the preferred timing structure is based on the determined based availability of a GPS based timing value, presence of a comparatively more precise clock value, an indication that the UE has access to a timing value based on a WAN, etc., or any combination thereof.

At block 1104, the UE may transmit timing information associated with the preferred timing structure during a synchronization channel duration associated with the first timing structure. In an aspect, the timing information may include a class identifier of the UE which indicates a preference level for the preferred timing structure.

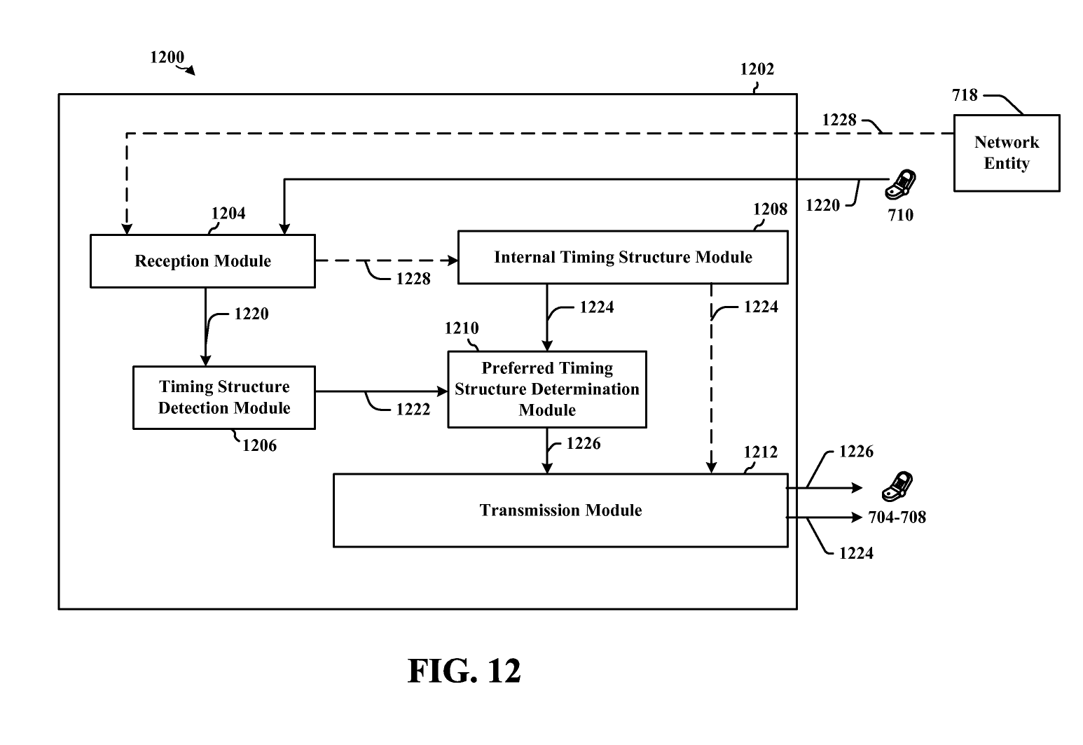

FIG. 12 is a conceptual data flow diagram 1200 illustrating the data flow between different modules/means/components in an example apparatus 1202. The apparatus may be a UE (e.g., UE 702). As described with reference to FIGS. 8, 9, and 10 the apparatus 1202 includes a reception module 1204, timing structure detection module 1206, internal timing structure module 1208, preferred timing structure determination module 1210, and transmission module 1212.

The apparatus may include additional modules that perform each of the steps of the algorithm in the aforementioned flow charts of FIGS. 9, 10, and 11. As such, each block in the aforementioned flow charts of FIGS. 9, 10, and 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

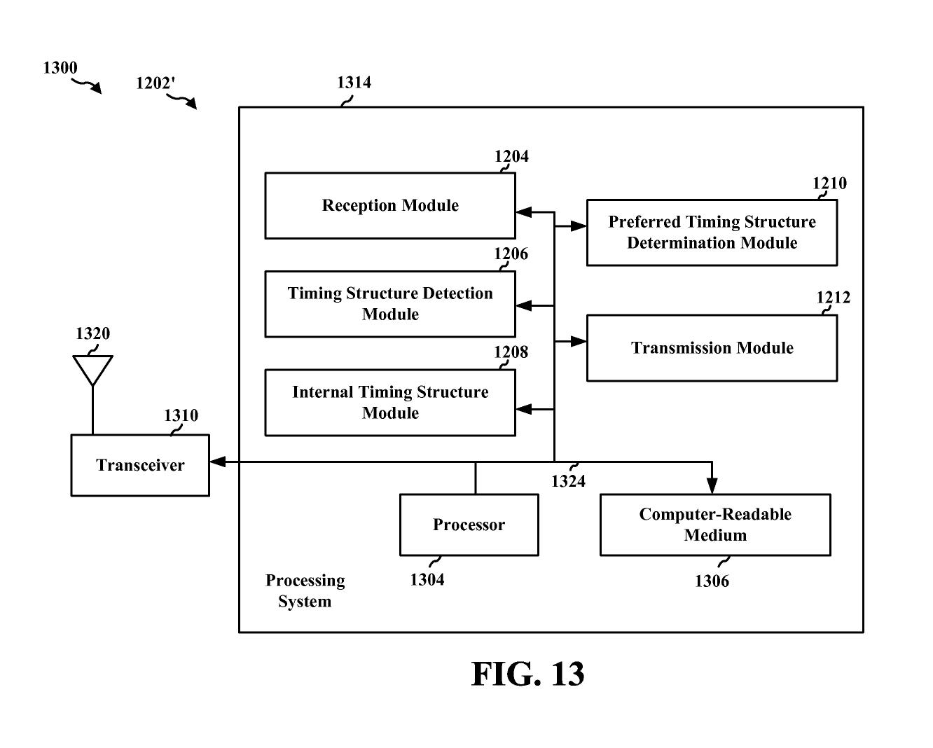

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, 1210, 1212, and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, 1208, 1210, and 1212. The modules may be software modules running in the processor 1304, resident/stored in the computer-readable medium 1306, one or more hardware modules coupled to the processor 1304, or some combination thereof. The processing system 1314 may be a component of the UE 550 and may include the memory 560 and/or at least one of the TX processor 568, the RX processor 556, and the controller/processor 559.

In one configuration, the apparatus 1202/1202′ for wireless communication, in a D2D network with distributed synchronization, includes means for detecting, by the UE, a synchronization signal during a listening slot duration scan of a communication channel, means for obtaining timing information associated with the second timing structure from the synchronization signal, and means for determining whether the first timing structure or the second timing structure is a preferred timing structure. In an aspect, the listening slot duration may be defined based on a first timing structure, and the synchronization signal may be defined based on a second timing structure. In an aspect, the apparatus 1202/1202′ may further include means for aligning with the second timing structure based upon the determination that the second timing structure is the preferred timing structure. In an aspect, the apparatus 1202/1202′ may include means for transmitting at least a portion of the obtained timing information during a synchronization channel associated with the first timing structure. In another aspect, the apparatus 1202/1202′ may include means for transmitting the at least the portion of the obtained timing information during a synchronization channel associated with any timing structure other than the preferred timing structure.

In another configuration, the apparatus 1202/1202′ for wireless communication, in a D2D network with distributed synchronization, includes means for detecting, by the UE, timing information received during a synchronization channel duration associated with a first timing structure, and means for aligning UE communications timing with the preferred timing structure. In an aspect, the timing information may be for a synchronization channel associated with a preferred timing structure which is different than the first timing structure. In an aspect, the apparatus 1202/1202′ means for aligning may be further configured to scan for a listening slot duration to detect a synchronization channel associated with the preferred timing structure.

In another configuration, the apparatus 1202/1202′ for wireless communication, in a D2D network with distributed synchronization, includes means for determining, by a UE, a presence of a preferred timing structure, and means for transmitting timing information associated with the preferred timing structure during a synchronization channel duration associated with the first timing structure. In an aspect, the UE may be currently using a first timing structure for communications, and the preferred timing structure may be different than the first timing structure.

The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 568, the RX Processor 556, and the controller/processor 559. As such, in one configuration, the aforementioned means may be the TX Processor 568, the RX Processor 556, and the controller/processor 559 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communications for a user equipment (UE) in a device-to-device (D2D) network with distributed synchronization, comprising:
detecting, by the UE, a synchronization signal during a listening slot duration scan of a communication channel, wherein the listening slot duration is defined based on a first timing structure, and wherein the synchronization signal is defined based on a second timing structure;
obtaining timing information associated with the second timing structure from the synchronization signal; and
determining whether the first timing structure or the second timing structure is a preferred timing structure.

2. The method of claim 1, further comprising:
aligning with the second timing structure based upon the determination that the second timing structure is the preferred timing structure.

3. The method of claim 2, further comprising:
transmitting at least a portion of the obtained timing information during a synchronization channel associated with the first timing structure.

4. The method of claim 2, further comprising:
transmitting the at least the portion of the obtained timing information during a synchronization channel associated with any timing structure other than the preferred timing structure.

5. The method of claim 3, wherein the synchronization channel includes a sub-channel allocated to periodically transmit timing information, and wherein an indicator associated with the at least the portion of the timing information is transmitted during the sub-channel.

6. The method of claim 3, wherein the synchronization channel includes a sub-channel allocated for random access, and wherein an indicator associated with the at least the portion of the timing information is transmitted during the sub-channel.

7. The method of claim 6, wherein the indicator comprises at least one of:
an indication that congestion in periodically used transmission resources is above a threshold value; or
a class identifier of the UE.

8. The method of claim 1, wherein the listening slot comprises a duration greater than or equal to a duration between two consecutive synchronization channel allocations in the first timing structure.

9. The method of claim 8, wherein the listening slot comprises multiple non-contiguous subslots.

10. The method of claim 1, wherein the listening slot is selected based on at least one of:
a pseudo-random slot determined each slow scale period; or
information associated with an identity of the UE.

11. The method of claim 1, wherein the timing information includes at least one of:
an indication of a presence of the preferred timing structure;
an identifier associated with the preferred timing structure; or
an offset between a synchronization channel associated with the first timing structure and the synchronization channel associated with the preferred timing structure.

12. A method of wireless communications for a user equipment (UE) in a device-to-device (D2D) network with distributed synchronization, comprising:
detecting, by the UE, timing information received during a synchronization channel duration associated with a first timing structure, wherein the timing information is for a synchronization channel associated with a preferred timing structure, and wherein the preferred timing structure is different than the first timing structure; and
aligning UE communications timing with the preferred timing structure.

13. The method of claim 12, wherein the aligning further comprises:
scanning for a listening slot duration to detect a synchronization channel associated with the preferred timing structure.

14. The method of claim 12, wherein the timing information includes an offset between a synchronization channel associated with the preferred timing structure and the synchronization channel associated with the first timing structure.

15. A method of wireless communications for a user equipment (UE) in a device-to-device (D2D) network with distributed synchronization, comprising:
determining, by the UE, a presence of a preferred timing structure, wherein the UE is currently using a first timing structure for communications, and wherein the preferred timing structure is different than the first timing structure; and
transmitting timing information associated with the preferred timing structure during a synchronization channel duration associated with the first timing structure.

16. The method of claim 15, wherein the timing information includes a class identifier of the UE which indicates a preference level for the preferred timing structure.

17. The method of claim 15, wherein the presence of the preferred timing structure is based on the determined based on at least one of:
availability of a global position system (GPS) based timing value;
presence of a comparatively more precise clock value; or
an indication that the UE has access to a timing value based on a wide area network (WAN).

18. An apparatus of wireless communications in a device-to-device (D2D) network with distributed synchronization, comprising:
means for detecting, by a user equipment (UE), a synchronization signal during a listening slot duration scan of a communication channel, wherein the listening slot duration is defined based on a first timing structure, and wherein the synchronization signal is defined based on a second timing structure;
means for obtaining timing information associated with the second timing structure from the synchronization signal; and
means for determining whether the first timing structure or the second timing structure is a preferred timing structure.

19. An apparatus of wireless communications in a device-to-device (D2D) network with distributed synchronization, comprising:
means for detecting, by a user equipment (UE), timing information received during a synchronization channel duration associated with a first timing structure, wherein the timing information is for a synchronization channel associated with a preferred timing structure, and wherein the preferred timing structure is different than the first timing structure; and
means for aligning UE communications timing with the preferred timing structure.

20. An apparatus of wireless communications in a device-to-device (D2D) network with distributed synchronization, comprising:
means for determining, by a user equipment (UE), a presence of a preferred timing structure, wherein the UE is currently using a first timing structure for communications, and wherein the preferred timing structure is different than the first timing structure; and
means for transmitting timing information associated with the preferred timing structure during a synchronization channel duration associated with the first timing structure.

21. A computer program product, comprising:
a computer-readable medium comprising code for:
detecting, by a user equipment (UE) in a device-to-device (D2D) network with distributed synchronization, a synchronization signal during a listening slot duration scan of a communication channel, wherein the listening slot duration is defined based on a first timing structure, and wherein the synchronization signal is defined based on a second timing structure;
obtaining timing information associated with the second timing structure from the synchronization signal; and
determining whether the first timing structure or the second timing structure is a preferred timing structure.

22. A computer program product, comprising:
a computer-readable medium comprising code for:
detecting, by a user equipment (UE) in a device-to-device (D2D) network with distributed synchronization, timing information received during a synchronization channel duration associated with a first timing structure, wherein the timing information is for a synchronization channel associated with a preferred timing structure, and wherein the preferred timing structure is different than the first timing structure; and
aligning UE communications timing with the preferred timing structure.

23. A computer program product, comprising:
a computer-readable medium comprising code for:
determining, by a user equipment (UE) in a device-to-device (D2D) network with distributed synchronization, a presence of a preferred timing structure, wherein the UE is currently using a first timing structure for communications, and wherein the preferred timing structure is different than the first timing structure; and
transmitting timing information associated with the preferred timing structure during a synchronization channel duration associated with the first timing structure.

24. An apparatus for communication in a device-to-device (D2D) network with distributed synchronization, comprising:
a processing system configured to:
detect, by a user equipment (UE), a synchronization signal during a listening slot duration scan of a communication channel, wherein the listening slot duration is defined based on a first timing structure, and wherein the synchronization signal is defined based on a second timing structure;
obtain timing information associated with the second timing structure from the synchronization signal; and
determine whether the first timing structure or the second timing structure is a preferred timing structure.

25. The apparatus of claim 24, wherein the processing system is further configured to:
align with the second timing structure based upon the determination that the second timing structure is the preferred timing structure.

26. The apparatus of claim 25, wherein the processing system is further configured to:
transmit at least a portion of the obtained timing information during a synchronization channel associated with the first timing structure.

27. The apparatus of claim 25, wherein the processing system is further configured to:
transmit the at least the portion of the obtained timing information during a synchronization channel associated with any timing structure other than the preferred timing structure.

28. The apparatus of claim 26, wherein the synchronization channel includes a sub-channel allocated to periodically transmit timing information, and wherein an indicator associated with the at least the portion of the timing information is transmitted during the sub-channel.

29. The apparatus of claim 26, wherein the synchronization channel includes a sub-channel allocated for random access, and wherein an indicator associated with the at least the portion of the timing information is transmitted during the sub-channel.

30. The apparatus of claim 29, wherein the indicator comprises at least one of:
an indication that congestion in periodically used transmission resources is above a threshold value; or
a class identifier of the UE.

31. The apparatus of claim 24, wherein the listening slot comprises a duration greater than or equal to a duration between two consecutive synchronization channel allocations in the first timing structure.

32. The apparatus of claim 31, wherein the listening slot comprises multiple non-contiguous subslots.

33. The apparatus of claim 24, wherein the listening slot is selected based on at least one of:
a pseudo-random slot determined each slow scale period; or
information associated with an identity of the UE.

34. The apparatus of claim 24, wherein the timing information includes at least one of:
an indication of a presence of the preferred timing structure;
an identifier associated with the preferred timing structure; or
an offset between a synchronization channel associated with the first timing structure and the synchronization channel associated with the preferred timing structure.

35. An apparatus for communication in a device-to-device (D2D) network with distributed synchronization, comprising:
a processing system configured to:
detect, by a user equipment (UE), timing information received during a synchronization channel duration associated with a first timing structure, wherein the timing information is for a synchronization channel associated with a preferred timing structure, and wherein the preferred timing structure is different than the first timing structure; and
align UE communications timing with the preferred timing structure.

36. The apparatus of claim 35, wherein the processing system is further configured to:
scan for a listening slot duration to detect a synchronization channel associated with the preferred timing structure.

37. The apparatus of claim 35, wherein the timing information includes an offset between a synchronization channel associated with the preferred timing structure and the synchronization channel associated with the first timing structure.

38. An apparatus for communication in a device-to-device (D2D) network with distributed synchronization, comprising:
a processing system configured to:
determine, by a user equipment (UE), a presence of a preferred timing structure, wherein the UE is currently using a first timing structure for communications, and wherein the preferred timing structure is different than the first timing structure; and
transmit timing information associated with the preferred timing structure during a synchronization channel duration associated with the first timing structure.

39. The apparatus of claim 38, wherein the timing information includes a class identifier of the UE which indicates a preference level for the preferred timing structure.

40. The apparatus of claim 38, wherein the presence of the preferred timing structure is based on the determined based on at least one of:
availability of a global position system (GPS) based timing value;
presence of a comparatively more precise clock value; or
an indication that the UE has access to a timing value based on a wide area network (WAN).
